(19) United States
(12) Patent Application Publication
(10) Pub. No.: US 2024/0273207 A1
(43) Pub. Date: Aug. 15, 2024

(54) INFORMATION PROCESSING DEVICE

(71) Applicant: Toyota Jidosha Kabushiki Kaisha, Toyota-shi (JP)

(72) Inventor: Sho Nakatani, Tokyo (JP)

(73) Assignee: Toyota Jidosha Kabushiki Kaisha, Toyota-shi (JP)

(21) Appl. No.: 18/532,325

(22) Filed: Dec. 7, 2023

(30) Foreign Application Priority Data
Feb. 15, 2023 (JP) 2023-021852

(51) Int. Cl. G06F 21/57; G06F 21/60

(52) U.S. Cl. CPC G06F 21/57; G06F 21/602

(57) ABSTRACT

An information processing device including a control unit configured to assign a transform of a first secure computation method to a node having a node attribute corresponding to the first secure computation method, the first secure computation method being one of a plurality of types of secure computation methods that is executed in distributed data processing, and the node being one of a plurality of nodes that is allocatable for the distributed data processing and that has at least one of node attributes corresponding to the secure computation methods.

### CROSS-REFERENCE TO RELATED APPLICATION

This application claims priority to Japanese Patent Application No. 2023-021852 filed on Feb. 15, 2023, incorporated herein by reference in its entirety.

### BACKGROUND

### 1. Technical Field

The present disclosure relates to information processing devices.

### 2. Description of Related Art

Conventionally, there is a technology that uses a trusted execution environment (TEE) or a secure tunnel in order to encrypt a communication channel that transfers data to a graphics processing unit (GPU) when fast execution of part of a homomorphic encryption process by the GPU is desired (e.g., Japanese Unexamined Patent Application Publication No. 2019-191575 (JP 2019-191575 A)).

### SUMMARY

It is an object of the present disclosure to provide an information processing device that can suitably perform distributed data processing for secure computation.

One aspect of the present disclosure is an information processing device including a control unit. The control unit is configured to assign a transform of a first secure computation method to a node having a node attribute corresponding to the first secure computation method, the first secure computation method being one of a plurality of types of secure computation methods that is executed in distributed data processing, and the node being one of a plurality of nodes that is allocatable for the distributed data processing and that has at least one of node attributes corresponding to the secure computation methods.

Aspects of the present disclosure may include an information processing method using the above information processing device, an information processing system including the above information processing device, a program that causes a computer to operate as the above information processing device, and a non-transitory recording medium recording the program.

According to the present disclosure, distributed data processing for secure computation can be suitably performed.

### BRIEF DESCRIPTION OF τHE DRAWINGS

Features, advantages, and technical and industrial significance of exemplary embodiments of the disclosure will be described below with reference to the accompanying drawings, in which like signs denote like elements, and wherein:

FIG. 1A is an explanatory diagram of distributed data processing;

FIG. 1B is an illustration of node attributes and transform assignments for nodes;

FIG. 2 is a diagram illustrating a configuration example of an information processing device;

FIG. 3 is a state transition diagram of a transform;

FIG. 4 is a flowchart illustrating an example of an assigning process;

FIG. 5 is a flowchart illustrating an example of an assigning process; and

FIG. 6 is a flowchart illustrating an example of scale-out and scale-in processing.

### DETAILED DESCRIPTION OF EMBODIMENTS

An information processing device according to an embodiment includes a control unit. The control unit is executed in distributed data processing for a plurality of nodes that are allocatable for the distributed data processing and that have at least one of node attributes corresponding to a plurality of types of secure computation methods. A transform of a first secure computation method among a plurality of kinds of secure computation methods is assigned to a node attribute having a node attribute corresponding to the first secure computation method.

An information processing device according to an embodiment will be described below with reference to the drawings. The configuration of the embodiment is an example, and is not limited to the configuration of the embodiment.

### Distributed Data Processing System

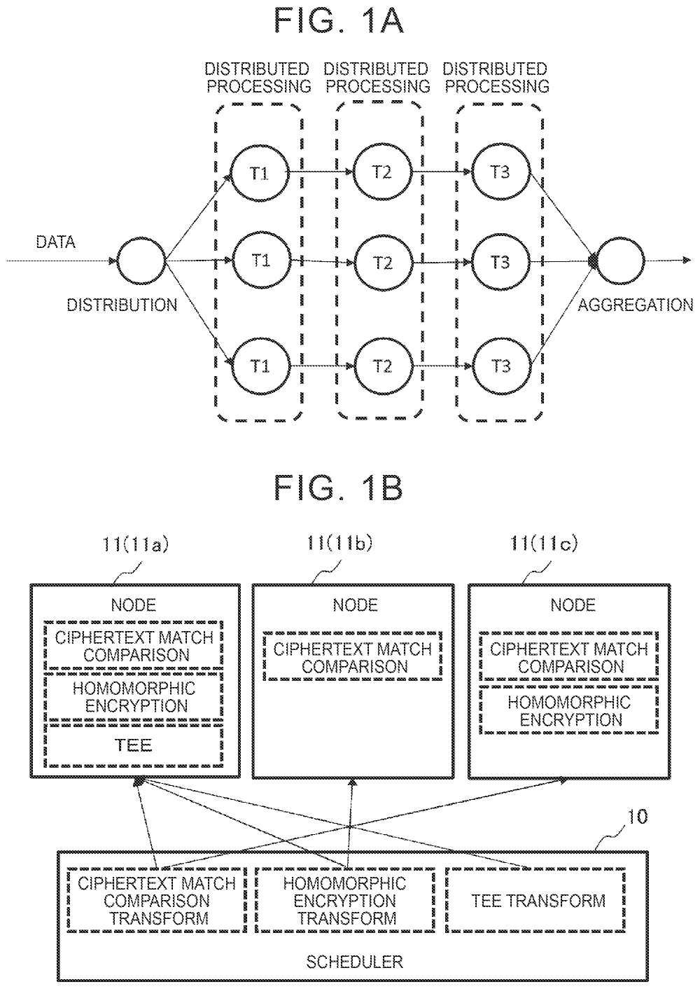

FIG. 1A shows an example of a distributed data processing system (distributed data processing system). FIG. 1A illustrates a system that performs distributed data processing in stream processing as an example of a distributed data processing system. However, the distributed data processing system and the method of assigning nodes or transforms, which will be described later, can be applied to both stream processing (real-time processing) and batch processing. In other words, the data subject to distributed data processing may be real-time data or non-real-time data. Note that stream processing is to process streaming data in real time. Streaming data is data that occurs indefinitely over time.

In FIG. 1A, data flows from left to right on the page. In a distributed data processing system, a plurality of nodes (processing elements) are arranged to perform predetermined processing on data. A node is a computer that performs predetermined processing. Appropriate units such as processes, processors (CPU, GPU, etc.), and servers can be adopted as the units of nodes.

In FIG. 1A, the leftmost node on the page performs distributed processing. In the next stage, a plurality of nodes (three are illustrated) that perform a certain transform T1 are arranged, and the transform T1 for data is distributed to the three nodes in the next stage. Such a method of distributing one process to a plurality of nodes is called distributed processing. Transforms are operations such as manipulations of data, calculations, and the like.

After each node that performs transform T1, three nodes that receive the output of transform T1 as an input and perform transform T2 that is different from transform T1 are arranged. Furthermore, three nodes that receive the output of the transform T2 as an input and perform a transform T3 that is different from the transform T2 are arranged after each node that performs the transform T3. After each node that performs the transform T3, a node that summarizes the processing results of each transform T3 is arranged.

Performing the next processing using the outputs of the processing elements (nodes) such as transform T1 to transform T2 to transform T3 as inputs to the next processing elements (nodes) is called pipeline processing. An array of nodes (processes) that perform flow operations such as transform T1, transform T2, and transform T3 is called a pipeline.

In the example of the distributed data processing system shown in FIG. 1A, distributed processing is configured such that three pipeline processes are executed in parallel, but the distributed data processing system is not limited to such a configuration. The number of nodes, the number of stages (steps), the number of distributed processes in one process, the type of transform, etc., which constitute the distributed data processing system, can be appropriately set according to the purpose of the secure computation. How transforms are assigned

FIG. 1B is a diagram illustrating a method of assigning node attributes and transforms performed in the embodiment. The node 11 is composed of a processor that executes processes, or a server having one or more processors. Although three nodes 11a to 11c are illustrated in FIG. 1B, the number of nodes 11 can be appropriately set as long as the number is larger than the distributed number in the case of distributed processing. The performance (processing speed, etc.) of the processors or servers constituting the node 11 may not be uniform. In this embodiment, a method of constructing a distributed data processing system that absorbs variations in performance between nodes 11 and is suitable (for example, obtains good throughput) will be described.

In this embodiment, it is assumed that secure computation is performed in distributed data processing by a distributed data processing system. Data manipulations, processes, calculations, and the like performed in secure computation are classified into one of a plurality of types of secure computation methods, and node attributes corresponding to each secure computation method are defined. The granularity of data manipulation, processing, or computation used for classifying secure computation methods can be set as appropriate.

In this embodiment, as an example, the secure computation method (including transforms and those relying on watermarks) includes a “ciphertext match comparison transform”, a “homomorphic encryption transform”, and a “Trusted Execution Environment (TEE) Transform”.

“Ciphertext match comparison transform” is a classification that focuses on a transform that compares a specific field (ciphertext) of an encrypted event with something to determine if it matches. Examples of transforms that fall under the category of “ciphertext match comparison transforms” are:
Filtering by constant match.

In this case, it is devised to register the pipeline with the constant part encrypted with the source data key.
Match judgment by comparison of join keys of INNER JOIN (Inner join: SQL syntax for joining tables)
Fields grouping

“Ciphertext match comparison transform” is mainly used to determine whether the objects to be compared match in the host memory, etc., so the cost (processing load, required hardware performance) and lower than the cost of “TEE Transform”.

“Homomorphic encryption transform” is a classification mainly for transforms in which data is operated while it is encrypted using homomorphic encryption. Homomorphic encryption is public-key encryption that can be calculated without decrypting the ciphertext. Homomorphic encryption includes additive homomorphic encryption, multiplicative homomorphic encryption, and fully homomorphic encryption.

Examples of transforms classified as “homomorphic encryption transforms” are:
Element-wise calculation such as four arithmetic operations
Time width window (assigning part)
Session window (window merging part)

The “homomorphic encryption transform” has a wider class of computation than the “ciphertext match comparison transform”. It can be an effective transform in situations where “TEE transform” cannot be used.

“TEE transform” is a classification mainly for transforms that perform calculations using TEEs. TEE is a hardware support technology for arranging confidential data in a trusted area and completing processing using the data within the trusted area. The trusted area is an isolated execution environment independent from the OS (operating system) called Enclave (isolated area), and cannot be referenced from the outside. Encrypted data is passed to an isolation area where it is decrypted and a transform operation is performed. TEE is an expensive technology that requires special hardware.

In this embodiment, it is preferable to classify at least the secure computation method (transform) into “TEE transform” and “non-TEE transform”.

Node attributes are prepared according to the classified result of the secure computation method (transform). In this embodiment, the following node attributes are prepared as an example. The number of types of node attributes can be prepared in accordance with the number of types of secure computation (2 or 4 or more).
Node attribute “Ciphertext match comparison node” corresponding to “Ciphertext match comparison transform”
The node attribute “Homomorphic Encryption Node” corresponding to “Homomorphic Encryption Transform” and
“TEE node” corresponding to “TEE transform”

Each node 11 is assigned at least one of the three types of node attributes described above.

In the example shown in FIG. 1B, a “ciphertext match comparison node”, a “homomorphic encryption node” and a “TEE node” are assigned to the node 11a. A “ciphertext match comparison node” is assigned to the node 11b. A “ciphertext match comparison node”, a “homomorphic encryption node”, and a “TEE node” are assigned to the node 11c.

The method of assigning node attributes to each of the nodes 11 can be carried out in consideration of the contents of transformation performed in distributed data processing, the hardware performance of each of the nodes 11, and the like. Each of the nodes 11 can take either a state (active state) in which transformation according to the node attribute can be executed or a dormant state (inactive state) for the assigned node attribute.

State transitions between active and inactive states are made by assigning transforms according to node attributes. The distributed data processing system assigns transforms to execution nodes at predetermined times, such as when pipeline processing starts, when the number of active nodes 11 increases or decreases, and when there are other scheduling opportunities.

Assignment is performed, for example, by a scheduler 10 as shown in FIG. 1B. However, it may be performed by an execution subject (such as a process) other than the scheduler 10.

The scheduler 10 assigns transforms to nodes 11 to which node attributes corresponding to the types (classifications) of transforms are assigned. In the example shown in FIG. 1B, the scheduler 10 can assign a “TEE transform” to the node 11a. Also, the scheduler 10 can assign a “homomorphic encryption transform” to the nodes 11a and 11c. The scheduler 10 can then assign the “ciphertext match comparison transform” to the nodes 11a, 11b and 11c. Such matching between transform types and node attributes ensures that each transform can be executed by the node 11 to which it is assigned.

### Hardware Configuration of Nodes and Schedulers

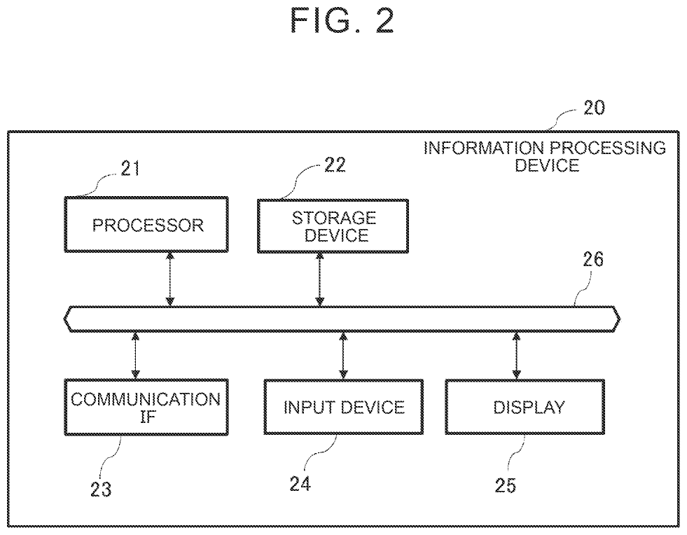

FIG. 2 is a diagram showing a hardware configuration example of an information processing device that can operate as the scheduler 10 and the node 11, respectively. In FIG. 2, the information processing device 20 can be configured using a dedicated or general-purpose information processing device (computer) such as a personal computer (PC), workstation (WS), or server machine. However, the information processing device 20 may be a collection (cloud) of one or more computers. Also, the node 11 may be a processor 21 installed in the information processing device 20 or a process executed by the processor 21.

The information processing device 20 includes a processor 21 as a processing unit or a control unit (controller), a storage device 22, a communication interface 23 (communication IF 23), and an input device 24, and the display 25, which are interconnected via a bus 26.

The storage device 22 includes a main storage device and an auxiliary storage device. The main memory is used as at least one of a program and data storage area, a program development area, a program work area, a communication data buffer area, and the like. The main memory is composed of RAM (Random Access Memory) or a combination of RAM and ROM (Read Only Memory). Auxiliary storage devices are used as storage areas for data and programs. A non-volatile storage medium is applied to the auxiliary storage device. The non-volatile storage medium is, for example, a hard disk, Solid State Drive (SSD), flash memory, or EEPROM (Electrically Erasable Programmable Read-Only Memory). The storage device 22 may also include a disk recording medium drive.

The communication IF 23 is a circuit that performs communication processing. For example, the communication IF 23 is a network interface card (NIC). Also, the communication IF 23 may be a wireless communication circuit that performs wireless communication (5G, wireless LAN (including Wi-Fi), BLE, etc.). Also, the communication IF 23 may be a combination of a circuit that performs wired communication processing and a wireless communication circuit.

The input device 24 includes keys, buttons, a pointing device, a touch panel, etc., and is used to input information. The display 25 is, for example, a liquid crystal display, and displays information and data.

The processor 21 performs various processes by executing various programs stored in the storage device 22. The information processing device 20 can operate as the scheduler 10 or the node 11 by the processor 21 executing the program stored in the storage device 22.

Processor 21 is, for example, a Central Processing Unit (CPU). A CPU is also called a Microprocessor Unit (MPU). The processor 21 may have a single processor configuration or a multiprocessor configuration. Also, a single physical CPU connected with a single socket may have a multi-core configuration. The processor 21 may include arithmetic units of various circuit configurations such as a Digital Signal Processor (DSP) or a Graphics Processing Unit (GPU). Also, the processor 21 may have a configuration that cooperates with at least one of an integrated circuit (IC), other digital circuits, analog circuits, and the like. Integrated circuits include LSIs, Application Specific Integrated Circuits (ASICs), programmable logic devices (PLDs), and the like. PLDs include, for example, Field-Programmable Gate Arrays (FPGAs). The processor 21 includes, for example, what is called a microcontroller (MCU), SoC (System-on-a-chip), system LSI, or chipset. Details of Assigning Method

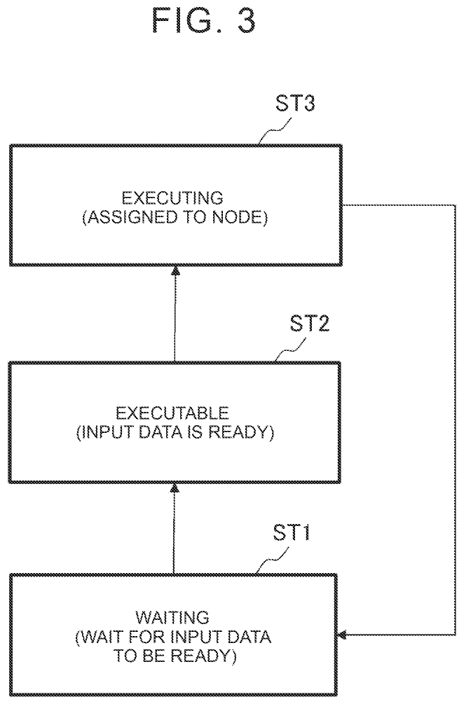

The details of the transform assigning method will be described below. FIG. 3 is a diagram showing an execution state of transform. A transform can take the states “waiting” (state ST1), “executable” (state ST2), and “executing” (state ST3). “Waiting” is a state of waiting for input data (data to be processed) necessary for transformation to be prepared. “Executable” is a state in which all input data are available. “Executing” indicates that the transform is assigned to node 11. The state transitions in a loop from “waiting” to “executable” to “executing” to “waiting.”

If the number of transforms, or the number of nodes 11 sufficient for the throughput of input data, the “executable” state can be eliminated. Conversely, since the “executable” state is a state of waiting for node 11 to become available, shortening the time in the “executable” state contributes to improving the throughput of the entire pipeline (distributed data processing system).

Therefore, the scheduler 10 measures the time in the “executable” state (that is, the time from when the input data (data to be processed) is ready until the execution of the transform starts: wait time). Perform processing to make it smaller (shorter).

For processing, the following quantities are defined.
Time during which any ciphertext match comparison transform τ_{Ecmp} is in the “executable” state:
t(τ_{Ecmp})
Time during which any homomorphic encryption transform T_{HE} is in the “executable” state:
t(τ_{HE})
Time during which any TEE transform T_{TEE} is in the “executable” state:
t(τ_{TEE})

Since there can be a plurality of transforms of various types, the following three types of transform wait times are defined as the sum of the wait times of transforms of the same type.

$${T}_{Ecmp} = \sum t ( {τ}_{Ecmp} ) , {T}_{H E} = \sum t ( {τ}_{H E} ) , {T}_{T E E} = \sum t ( {τ}_{TEE} )$$

In order to actually operate the matching of transform types and node attributes, it is necessary to solve the problem of “to which node 11 should a particular type of transform at a certain time be assigned?” This question can be replaced with “how to make the node 11 behave at a certain point in time”.

### First Process Example

For example, T_{TEE} being greater than T_{HE} and T_{Ecmp} indicates a relatively long (longest) wait time for the TEE transform in the overall distributed data processing system. In this case, the number of active TEE nodes (nodes 11 having the node attribute “TEE node”) is increased. Thereby, the wait time of the TEE transform can be reduced.

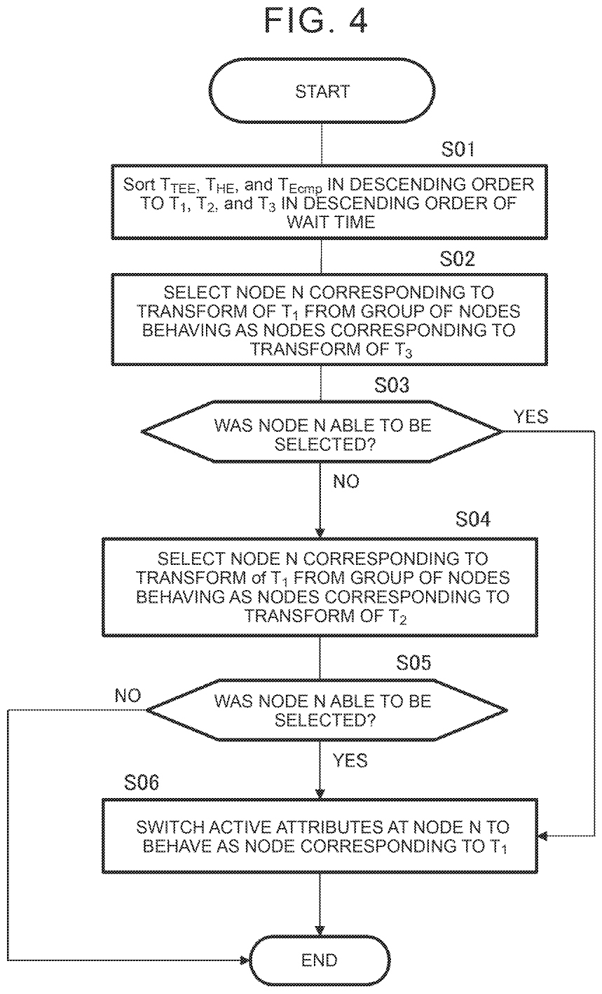

In other words, the processing shown in FIG. 4 is executed at the opportunity of transform scheduling (opportunity to change the behavior of the node 11) to switch (change) the behavior of a certain node 11 to that of a TEE node.

FIG. 4 is a flowchart illustrating an example of a transform assigning process (first process example). The processing shown in FIG. 4 is executed by the processor 21 of the information processing device 20 operating as the scheduler 10, for example.

In S01, the processor 21 sorts T_{TEE}, T_{HE}, and T_{Ecmp} in descending order and defines them as T₁, T₂, and T₃ in descending order of wait time.

In S02, the processor 21 selects node N (corresponding to the first node) having node attributes corresponding to T₁, i.e., the transform of the secure computation method with the longest wait time (corresponding to the first secure computation method) from the group of nodes that are behaving as nodes with node attributes corresponding to T₃, i.e., the transform of the secure computation method with the shortest wait time (corresponding to the second secure computation method). Selection may be random or according to predetermined rules.

In S03, the processor 21 determines whether or not a node N satisfying the conditions has been selected. If it is determined that the node N has been selected, the process proceeds to S05; otherwise, the process proceeds to S04.

In S04, the processor 21 selects node N (corresponding to the second node) having node attributes corresponding to T₁, i.e., the transform with the longest wait time from the group of nodes that are behaving as nodes with node attributes corresponding to T₂, i.e., the transform of the secure computation method with the next shortest wait time (corresponding to the third secure computation method). Selection may be random or according to predetermined rules.

In S05, the processor 21 determines whether or not a node N satisfying the conditions has been selected. If it is determined that the node N has been selected, the process proceeds to S06; otherwise, the process of FIG. 4 ends assuming that there is no node 11 that satisfies the condition.

In S06, the processor 21 switches (switches the operation) so that the node N behaves (operates) as the node 11 having the node attribute corresponding to T₁. According to the first process example, it is possible to reduce the wait time of the transform having the longest wait time (for example, the TEE transform), and improve resource efficiency.

### Second Process Example

When focusing only on the wait time as in the first process example, resource efficiency can be expected to improve. However, it does not necessarily improve the efficiency of data processing. For example, there is a concern that the efficiency of cache utilization will decrease as a particular node 11 frequently changes its node attributes. Therefore, processing that takes into account data processing throughput, which is a direct index of processing efficiency, is conceivable.

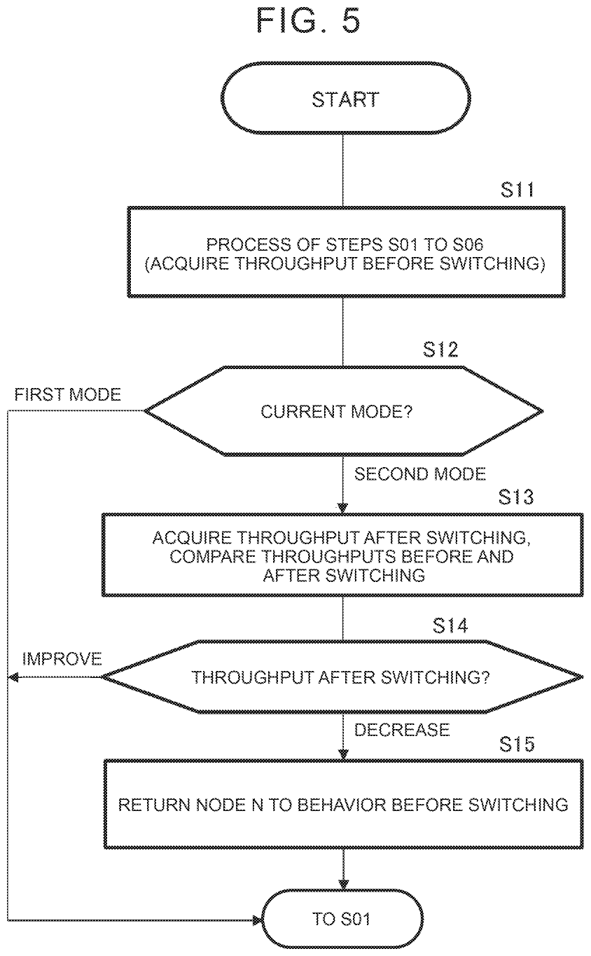

FIG. 5 is a flowchart illustrating an example of a transform assigning process (second process example). The processing shown in FIG. 5 is executed by the processor 21 of the information processing device 20 operating as the scheduler 10, for example.

In S11, the processor 21 performs the processing from S01 to S06 shown in FIG. 4. However, in the second process example, when the processing of S06 is performed, the processor 21 acquires a value indicating the throughput of the distributed data processing before switching (corresponding to the first throughput).

A value indicating the throughput may be obtained by the processor 21 measuring the throughput and storing it in the storage device 22. Alternatively, the processor 21 may acquire a value indicating the throughput measured by a device other than the processor 21 and store it in the storage device 22. In S11, when the process of S06 is performed, the process proceeds to S12.

In S12, the processor 21 determines whether the current mode is the first mode for performing the first process shown in FIG. 4 or the second mode for performing step S13 and the subsequent steps. If it is determined to be the first mode, the process of FIG. 5 ends, and if it is determined to be the second mode, the process proceeds to S13.

In S13, the processor 21 acquires a value indicating the throughput of distributed data processing after switching (corresponding to the second throughput) and stores it in the storage device 22. Then, at the next scheduling opportunity, the processor 21 retrieves and compares the values indicating the throughput before and after switching the behavior of the node N from the storage device 22.

In S14, the processor 21 determines whether the throughput after switching is improved or decreased compared to the throughput before switching. If it is determined that the throughput is improved, the process returns to S01 while maintaining the post-switch state.

On the other hand, when it is determined in S14 that the throughput has decreased, the process proceeds to S15. In S15, the processor 21 restores the behavior of the node N to the behavior before switching, and then returns the processing to S01. This eliminates the concerns described above and enables efficient data processing. Node scale-out and scale-in

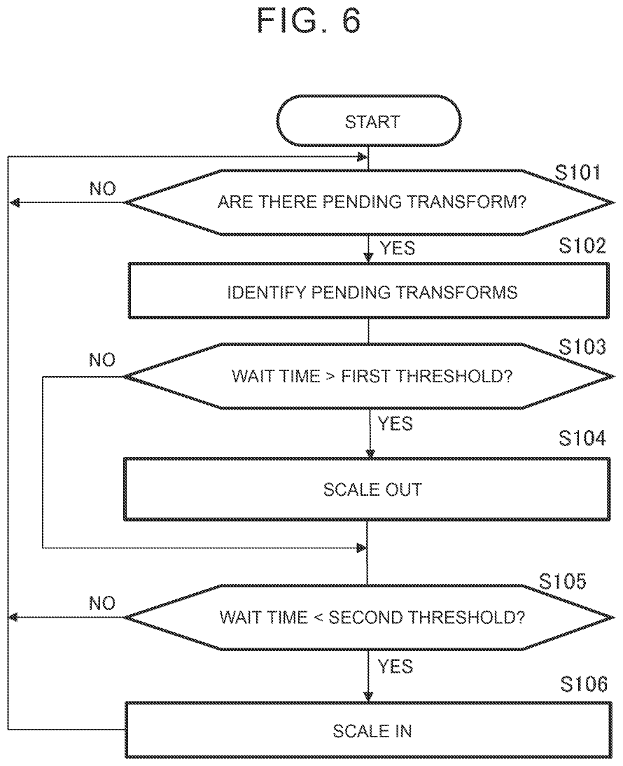

FIG. 6 is a flowchart illustrating an example of processing related to node scale-out and scale-in. The processing of FIG. 6 is executed by the processor 21 of the information processing device 20 operating as the scheduler 10, for example.

At S101, the processor 21 determines whether there is an idle transform. If it is determined that there is a standby transform, the process proceeds to S102; otherwise, the process returns to S101.

At S102, the processor 21 identifies one of the waiting transforms. A specific rule in the case of multiple pending transforms is optional.

In S103, the processor 21 determines whether or not the wait time of the transform identified in S102 is equal to or greater than (or exceeds) a first threshold. If it is determined that the standby time is equal to or greater than the first threshold, the process proceeds to S104; otherwise, the process proceeds to S105.

In S104, the processor 21 performs scale-out processing. That is, the processor 21 performs scale-out in a form that causes non-active nodes having node attributes corresponding to the specified transform to participate in the distributed processing. The scale-out process attempts to reduce the latency of the identified transforms.

When the process proceeds to S105, the processor 21 determines whether or not the wait time of the specified transform is less than (or less than) a second threshold different from the first threshold. When the standby time is determined to be less than the second threshold, the process proceeds to S106, otherwise the process returns to S101.

In S106, the processor 21 performs scale-in processing. That is, the processor 21 scales in such a manner as to withdraw from the distributed processing a node having a long active state elapsed time from among the nodes in the active state performing the behavior (operation) of the node attribute corresponding to the specified transform. Scaling in reduces processing execution costs. A node with a long elapsed time is a node selected at random or according to a predetermined rule from nodes with the longest elapsed time or nodes with an elapsed time exceeding a threshold.

Note that the order of the processing of S102 and S103 and the processing of S104 and S105 may be reversed. When the process returns from S105 to S101, that is, in a region where the wait time does not exceed the first threshold and does not fall below the second threshold, the transform waiting state is maintained. However, it is also conceivable to set the first and second thresholds to the same value so that either scale-in or scale-out is performed.

### Effects of the Embodiment

In the embodiment, the distributed data processing system includes a plurality of nodes 11 that can be allocated for the distributed data processing, and among the node attributes corresponding to a plurality of types of secure computation methods (ciphertext match comparison, homomorphic encryption, TEE), a plurality of nodes 11 having at least one of In addition, the distributed data processing system includes an information processing device 20 including a control unit (including a processor 21 that executes the scheduler 10) configured to assign a transform of a first secure computation method (any of ciphertext match comparison, homomorphic encryption, and TEE) out of a plurality of types of secure computation methods that is executed in distributed data processing to a node having a node attribute corresponding to the first secure computation method out of a plurality of nodes 11.

By such assignment, it is possible to appropriately assign transforms for distributed data processing, and to perform efficient distributed data processing.

When the first secure computation method (e.g., TEE) is the secure computation method with the longest wait time from the collection of data to be processed to the start of processing among multiple types of secure computation methods. Furthermore, the control unit (processor 21) operates as the node 11 that executes the transformation of the second secure computation method (for example, ciphertext match comparison) whose wait time is the shortest among the plurality of types of secure computation methods. A transform of the first secure computation method can be assigned to a first node among the plurality of nodes 11 having a node attribute corresponding to the first secure computation method. As a result, the wait time can be shortened.

When no node falls under the first node, the control unit (processor 21) waits for the first secure computation method longer than the wait time for the second secure computation method among the plurality of types of secure computation methods. A plurality of nodes operating as nodes 11 executing transforms for a third secure computation method (e.g., homomorphic encryption) with a wait time longer than time and having node attributes corresponding to the first secure computation method. A second node in 11 may also be assigned a transform of the first secure computation method. Also in this case, the wait time can be shortened.

The control unit (processor 21) controls the first throughput when the first node operates as the node 11 executing the transform of the second secure computation method and the first node performs the second secure computation. It is determined that the second throughput is lower than the first throughput in comparison with the second throughput when operating as the node 11 executing the transform of the first secure computation method instead of the method. If so, the first node may be restored to the state before the transform of the first secure computation method is assigned. This allows assignment in consideration of throughput.

The control unit (processor 21) can compare the first throughput when the second node operates as a node that executes the transform of the second secure computation method with a second throughput when the first node operates as a node executing the transform of the first secure computation method instead of the second secure computation method. If the comparison determines that the second throughput is lower than the first throughput, the second node can be restored to the state before the transform of the first secure computation method is assigned. This allows assignment in consideration of throughput.

When there is a first method out of the secure computation methods, the control unit (processor 21) can perform assignment of a transform of the first method to a node so as to increase the number of nodes that execute the transform of the first method, the first method being a secure computation method with a wait time longer than a first threshold, the wait time being a time period from data to be processed is ready until start of execution of a process. When there is a second method out of the secure computation methods, the processor 21 can stop assigning a transform of the second method to a node 11 to which the transform of the second method has been continuously assigned for a long time, the second method being a secure computation method with the wait time shorter than a second threshold, and the second threshold being smaller than the first threshold.

The embodiments and modifications described above are merely examples, and the present disclosure can be modified as appropriate without departing from the gist thereof. Also, the processes and means described in the present disclosure can be freely combined and implemented as long as there is no technical contradiction.

The process described as being performed by one device may be shared and performed by a plurality of devices. Alternatively, processes described as being performed by different devices may be performed by one device. In the computer system, it is possible to flexibly change the hardware configuration (server configuration) to realize each function.

The present disclosure can also be implemented by supplying a computer program implementing the functions described in the above embodiments to a computer, and reading and executing the program by one or more processors of the computer. Such a computer program may be provided to the computer by a non-transitory computer-readable storage medium connectable to the system bus of the computer, or may be provided to the computer via a network. A non-transitory computer-readable storage medium is any type of disk such as, for example, a magnetic disk (floppy disk, hard disk drive (HDD), etc.), an optical disk (CD-ROM, DVD disk, Blu-ray disk, etc.), It includes any type of medium suitable for storing electronic instructions, such as read only memory (ROM), random access memory (RAM), EPROM, EEPROM, magnetic cards, flash memory, or optical cards.

What is claimed is:

1. An information processing device comprising a control unit configured to assign a transform of a first secure computation method to a node having a node attribute corresponding to the first secure computation method, the first secure computation method being one of a plurality of types of secure computation methods that is executed in distributed data processing, and the node being one of a plurality of nodes that is allocatable for the distributed data processing and that has at least one of node attributes corresponding to the secure computation methods.

2. The Information processing device according to claim 1, wherein the control unit is configured to, when the first secure computation method is a secure computation method with a longest wait time out of the secure computation methods, assign the transform of the first secure computation method to a first node, the wait time being a time period from when data to be process is ready until start of execution of a process, the first node being one of the nodes that have the node attribute corresponding to the first secure computation method and that are operating as nodes that execute a transform of a second secure computation method, and the second secure computation method being a secure computation method with a shortest wait time out of the secure computation methods.

3. The information processing device according to claim 2, wherein the control unit is configured to, when no node falls under the first node, assign the transform of the first secure computation method to a second node, the second node being one of the nodes that have the node attribute corresponding to the first secure computation method and that are operating as nodes that execute a transform of a third secure computation method, and the third secure computation method being a secure computation method with the wait time longer than the wait time of the second secure computation method and longer than the wait time of the first secure computation method out of the secure computation methods.

4. The information processing device according to claim 2, wherein the control unit is configured to, when a first throughput and a second throughput are compared and the second throughput is determined to be lower than the first throughput, restore the first node to a state before the transform of the first secure computation method is assigned, the first throughput being a throughput when the first node is operating as a node that executes the transform of the second secure computation method, and the second throughput being a throughput when the first node is operating as a node that executes the transform of the first secure computation method instead of the second secure computation method.

5. The information processing device according to claim 3, wherein the control unit is configured to, when a first throughput and a second throughput are compared and the second throughput is determined to be lower than the first throughput, restore the second node to a state before the transform of the first secure computation method is assigned, the first throughput being a throughput when the second node is operating as a node that executes the transform of the second secure computation method, and the second throughput being a throughput when the first node is operating as a node that executes the transform of the first secure computation method instead of the second secure computation method.

6. The information processing device according to claim 1, wherein the control unit is configured to
when there is a first method out of the secure computation methods, perform assignment of a transform of the first method to a node so as to increase the number of nodes that execute the transform of the first method, the first method being a secure computation method with a wait time longer than a first threshold, the wait time being a time period from data to be processed is ready until start of execution of a process, and
when there is a second method out of the secure computation methods, stop assigning a transform of the second method to a node to which the transform of the second method has been continuously assigned for a long time, the second method being a secure computation method with the wait time shorter than a second threshold, and the second threshold being smaller than the first threshold.
